(19) United States
(12) Patent Application Publication
(10) Pub. No.: US 2005/0102123 A1
(43) Pub. Date: May 12, 2005

(54) Method and system for modeling a protein using MEL script

(76) Inventor: Samantha Surrey, Princeton Junction, NJ (US)

Correspondence Address: CESARI AND MCKENNA, LLP, 88 BLACK FALCON AVENUE, BOSTON, MA, 02210, US

(21) Appl. No.: 10/706,719

(22) Filed: Nov. 12, 2003

(51) Int. Cl. G01N 31/00

(52) U.S. Cl. 703/12

(57) ABSTRACT

A method and system for modeling a 3-dimensional structure of a protein using animation software techniques is provided. In one embodiment of the invention, the modeling is based upon identifying a 3-dimensional structure of a protein. Positional data regarding that 3-dimensional structure, more specifically, the X, Y and Z coordinates for the structure, are generated. Using these coordinates, an animation software, such as MEL (Maya Embedded Language) Script or “melscript” is employed that uses the co-ordinates to create an image of animation information to be displayed on a computer screen, or other visual medium. Further refinement techniques are used to improve the accuracy of the representation in animation. The model of the protein is thereby generated as an animation of the protein and it can be displayed and evaluated accordingly.

### BACKGROUND OF THE INVENTION

1. Field of the Invention

This invention relates generally to modeling 3-dimensional structures of proteins.

### BACKGROUND INFORMATION

In many bioscience and biotechnology applications, it is important to know the 3-dimensional structures of proteins. In order to determine the 3-dimensional structures of some proteins, they can be subjected to x-ray crystallography or nuclear magnetic residence imaging in order to determine their structure. However, other proteins are not amenable to such examination. Conventionally, modeling techniques involve building models of separate portions of proteins initially and then adding these items together. Unknown quantities are assigned the same values as similar, known models. For example, proteases and antibodies have been modeled by taking the Cartesian coordinates of a homologous amino acid in a template protein with a known 3-dimensional structure and using this information, including these coordinates, as a starting point. The information about protein structures is maintained in, for example, a protein databank administered by the Brook Haven National Laboratory.

More specifically, it has been known to provide a computer-implemented method and system for modeling a 3-dimensional structure of a model protein, in which the modeling is based upon the 3-dimensional structure of a template protein and an amino sequence alignment of the model protein and the template protein. The proteins comprise a plurality of amino acids having backbone atoms and side chain atoms. For each amino acid on the model protein, when the template protein has an amino acid aligned with the amino acid of the model protein, the position of each backbone atom of the model protein is established based on the position of a topologically equivalent backbone atom and the aligned amino acid of the template protein. Then, the interatomic distance constraints from each pair of atoms with an established position is generated. Finally, the position of each atom in the model protein is set so that the interatomic distances are in accordance with the constraints. U.S. Pat. No. 5,884,230 (Srinivasan, et al.), that was issued on Mar. 16, 1999 for a METHOD AND SYSTEM FOR PROTEIN MODELING.

These techniques can be generally successful in modeling structurally conserved regions of the family of proteins. However, such techniques have been unsuccessful in modeling variable regions. When various intervariable regions are grafted from different known protein structures, this can result in unreliable data. Sometimes, with the sequence identity in the structurally conserved regions between the template and the model protein is weak, interior amino acids can be susceptible to short contacts. Sometimes these are removed using graphics programs, but this can be tedious and impractical at other times. In summary, these techniques can be tedious, time consuming and expensive among other disadvantages.

Accordingly, there remains a need for a system and method for modeling proteins that is straightforward, and reliable.

It is thus an object of the present invention to provide a solution for modeling proteins that are not amenable to imaging and other known methods for modeling proteins and which can be implemented in software.

### SUMMARY OF THE INVENTION

The disadvantages of prior techniques have been overcome by the present invention, which provides a method and system for modeling a 3-dimensional structure of a protein using animation software techniques. In one embodiment of the invention, the modeling is based upon identifying the 3-dimensional structure of a protein using positional data. More specifically, the X, Y and Z coordinates for the structure, are obtained form a database, or are otherwise determined. Using these coordinates, in accordance with the present invention, animation software, such as MEL (Maya Embedded Language) Script or “melscript” is employed to convert the coordinates to animation information to be displayed on a computer screen, or other visual medium. The melscript is used to create an image based upon “Non-Uniform Rational B-splines” (“NURBS”) and spheres. The model of the protein is thereby generated as an animation of the protein and it can be displayed and evaluated accordingly.

### BRIEF DESCRIPTION OF THE DRAWINGS

The invention description below refers to the accompanying drawings, of which:

FIG. 1 is an overall block diagram of the input and output of the protein modeler of the present invention;

FIG. 2 is a flow chart of the method of modeling a protein in accordance with the present invention;

FIG. 3A is a screen shot of a protein being animated in accordance with the present invention;

FIG. 3B is a screen shot of spheres generated by the software program of the present invention before being connected;

FIGS. 4A and 4B together form a flow chart illustrating further details of the procedure of the present invention;

FIG. 5 is a screen shot of a render editor window used in accordance with the invention; and

FIG. 6 is a perspective view of water molecules in a rendering sequence in accordance with the invention.

### DETAILED DESCRIPTION OF AN ILLUSTRATIVE EMBODIMENT

By way of background, a 3-dimensional structure of a protein can be identified by a number of techniques that are known to those skilled in the art. For example, a template protein could be used with a known 3-dimensional structure and an amino acid sequence alignment between the model protein and the template protein. Using the template protein and the sequence alignment, known software generates a variety of interatom distance constraints for conserved regions and standard and chemical constraints for variable regions. This allows for the input of miscellaneous constraints. The protein modeler then generates a 3-dimensional structure of the model protein using known techniques of distance geometry to ensure compliance with the constraints.

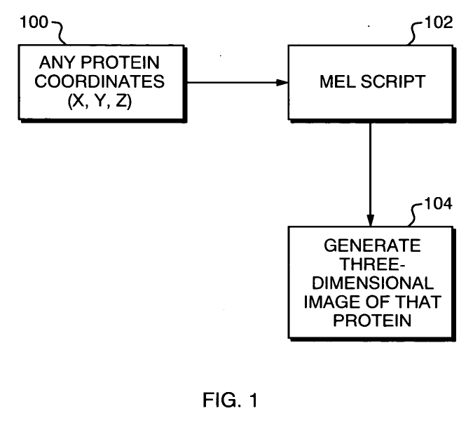

In accordance with the present invention, once the 3-dimensional structure is identified, or the X, Y and Z coordinates of the protein are known, the program and system of the present invention generates a 3-dimensional animation of the model protein. More specifically, FIG. 1 is a schematic block diagram of the system of the present invention. The input to the system includes the protein (X, Y and Z) Cartesian coordinates identified by block 100. As noted, protein coordinates can be known or can be identified by known techniques for modeling proteins. For purposes of this illustration, it is assumed that the protein's X, Y, Z coordinates are already known.

The coordinates 100 are the input to a computer program written in accordance with the present invention, preferably using melscript, which is schematically represented as block 102 in FIG. 1. The program 102 is then used to convert the coordinates of the atom portion of the proteins using melscript, which includes instructions to create the model of the protein using NURBS and spheres.

By way of background, a 3-dimensional object can be modeled through the use of subdivision simulation in a melscript program. The melscript contains software that is representational, based on the coordinates that are input to it, and which also includes smoothing techniques to provide a more accurate representation of the underlying object being modeled.

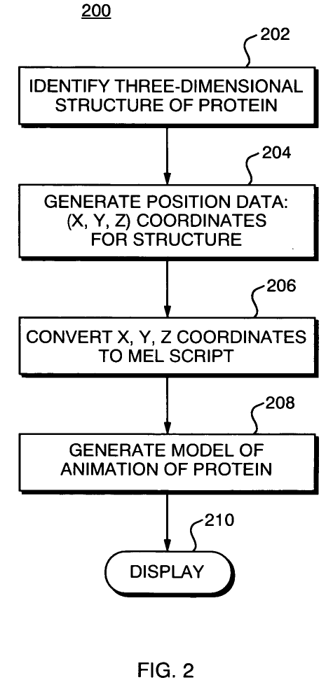

FIG. 2 is a flow chart of a procedure 200 in accordance with the method of the present invention for generating a protein model. The first step 202, is to identify the 3-dimensional structure of the protein using known techniques. In accordance with step 204, the positional data is generated, such as the X, Y and Z coordinates for the protein structure that had been identified in step 202.

In accordance with step 206, these X, Y and Z coordinates are used by the melscript to create an images based upon NURBS and spheres to generate the model as an animation of the protein as illustrated in step 208. Finally in step 210, the model is displayed or otherwise used for appropriate evaluation such as in a research and development environment to add to the recently discovered information, such as the DNA code of the protein, but researchers are also thus provided with an accurate image of the protein as well.

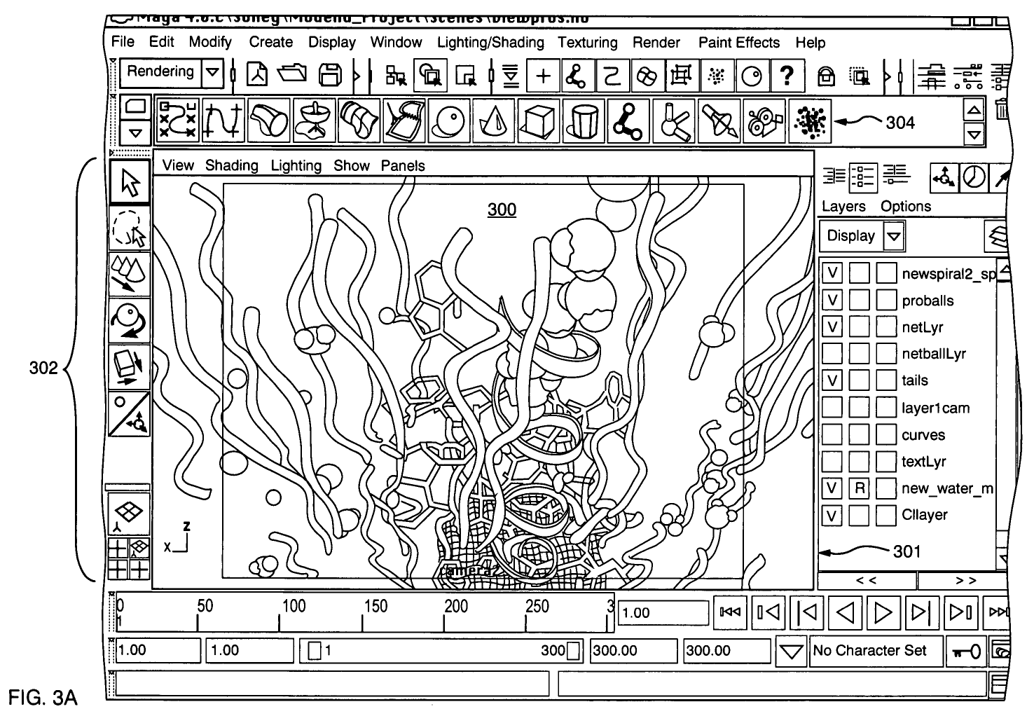

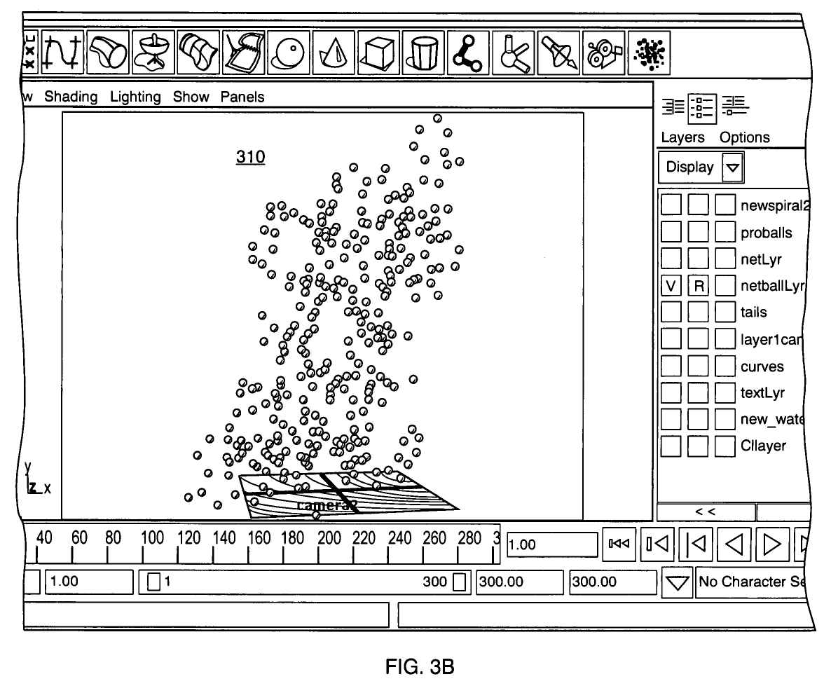

Referring to FIGS. 3A and 3B, a protein image 300 (FIG. 3A) produced in accordance with the program of the present invention is illustrated. The computer screen shot of FIG. 3A illustrates how a computer program having the graphic user interface of FIG. 3 can be used to create the protein in the window 301, while using the tool buttons such as 302, 304 to manipulate and refine the animation.

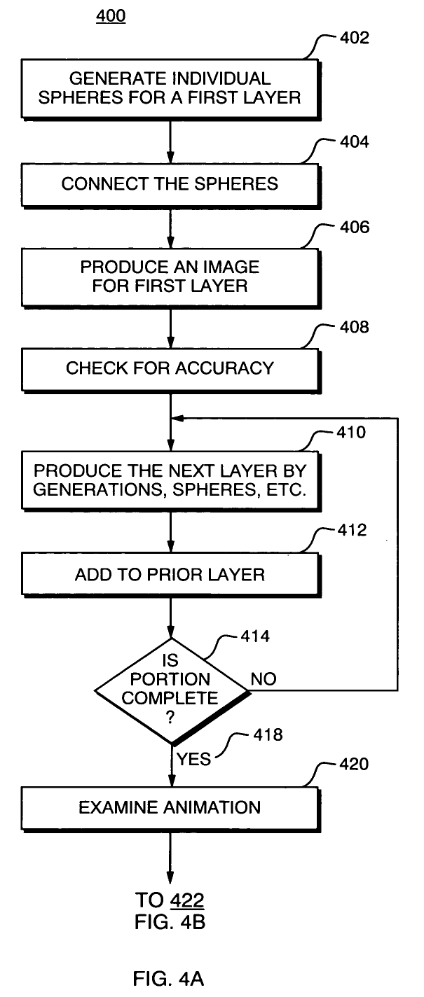

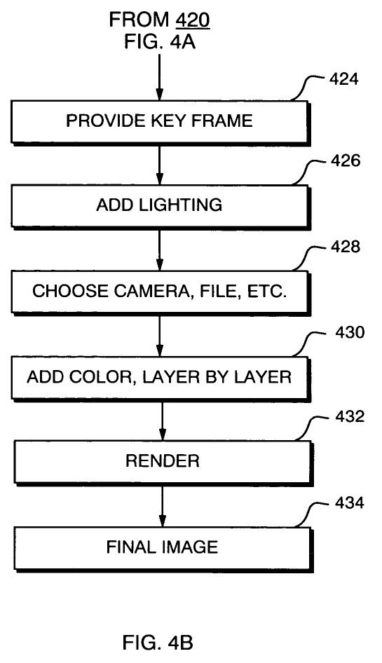

In accordance with one aspect of the invention, portions of the protein can be animated using spheres to represent each atom that are connected, and NURBS to produce the remainder of the image thus creating nodes that have coordinates (X, Y and Z) on a Cartesian coordinate graph. In accordance with the invention, as illustrated in the flow chart of FIGS. 4A and 4B, the first step is to use the melscript to describe the connections of carbon molecules. For example, carbon molecules can be represented as individual spheres as shown in step 402 and its connection to the next sphere can also be illustrated in the script. The spheres before they are connected are illustrated in the screen shot 310 of FIG. 3B. The next step in the program is to connect the spheres, as shown in step 404. One way in which to identify coordinates to the melscript is to place the coordinates into a
−p [0,0,0] variable format

Now, to connect the spheres, another portion of the program connects the selected spheres with a “pipe”. A NURB could be used in accordance with this aspect, although other surface producing techniques are also known and may be employed. This includes generating a vector between the two points to be connected and drawing a circle around the individual points, which is then joined by a connector. Thus, the given spheres are selected that need to be connected in a given order and the script is run to join the two points. The script is then run to join all of the points in the image. This produces an image, as shown in step 406, and the image is checked for accuracy, such as the accuracy of the bond angles, as shown in step 408. The modeling process can involve producing new images that are added together as individual layers. In other words, in accordance with one aspect of the invention, the modeling is performed in a layer format in which the layers are then placed on top of one another and this allows ease of changing individual layers in animation. In addition, layers can be turned on and off in a channel box to examine separate layer more closely. Each layer is thus produced separately as illustrated in steps 410 through 418.

After modeling the inner portion of the protein, the next set of layers consists of animating the outside regions of the protein. For those outside regions, which are comprised primarily of hydrogen and oxygen, the melscript in accordance with the present invention identifies the hydrogen and oxygen in the coordinate format of −p[0,0,0]format. The script is given float variables that include the radius of the hydrogen and oxygen and the Cl molecules at the latter half of the protein. These float variables will change depending upon the particular protein being modeled.

After each individual portion of the protein is modeled on a layer-by-layer basis and the models are placed together, the overall image generated by the animation software can include some errors, so this initial animation image is examined, as shown in step 420. Molecules can be separated using tools such as a “move” tool to reposition water molecules on the side of the protein.

Now the individual layers created are animated. Several types of animation are available as follows: a key frame, a path, a non-linear and a reactive animation. In accordance with the invention, the key frame animation is used as shown in step 424. However, there may be other types of animation techniques that are similarly employed in accordance with the present invention in order to model a protein using other types of animation software, while remaining within the scope of the present invention. The final portion of the animation is to place the keys in a dependency graph editor in order to refine and smooth the animation.

Appropriate lighting (step 426) and camera angles can also be used to enhance the animation (step 428). Coloring is also an important aspect of making an animation appear correctly. Each molecule is appropriately colored and, as the model is created in layers, so the colors are added to each layer as illustrated in step 430.

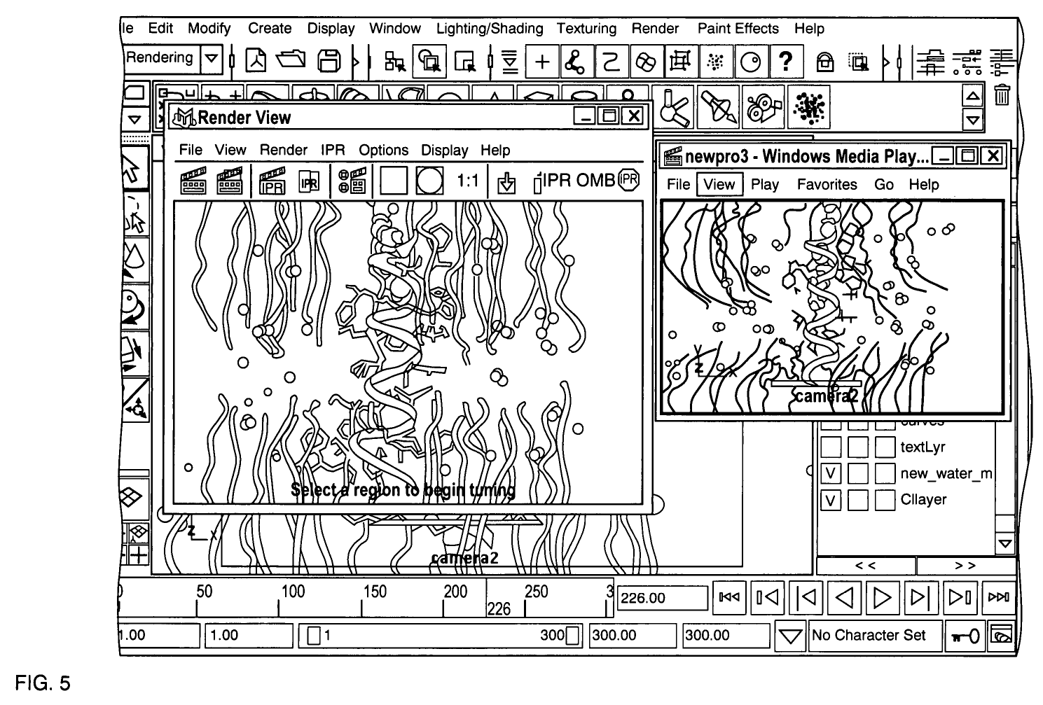

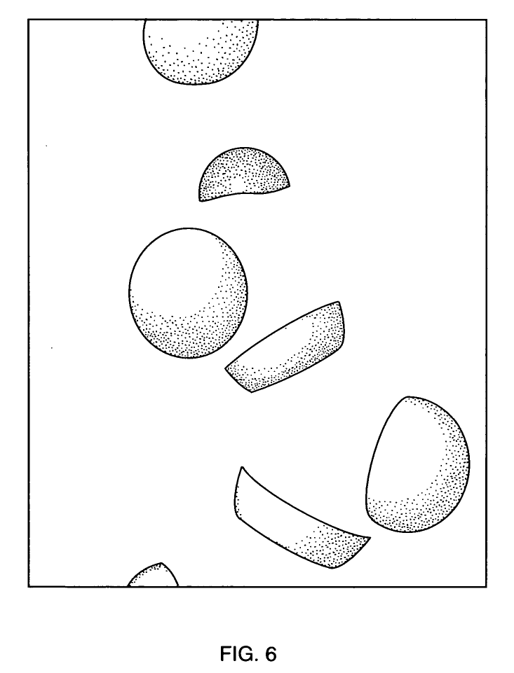

The final step of the animation is rendering as shown in step 432. Rendering a sequence gives the animation its depth. To render the image, render globals are set for that particular image. Render globals are a set of global attributes that are set to define how the scene will render. The software will include a render view manual and a render editor and this can be used to set the render globals and then turn motion blur off so that there will be no shadows behind the animation scene. A screen shot of the render editor window is illustrated in FIG. 5. In addition, a perspective view of the water molecules in the rendering sequence is illustrated in FIG. 6.

After all of this is completed, the rendering view can be performed to evaluate how the image appears as shown in step 434.

It should be understood that the techniques and system of the present invention provide an improved and simplified technique for modeling 3-dimensional protein structures that up to now has been a difficult and laborious task. In addition, the techniques of the present invention can be employed with known animation software that is available commercially.

Although the present invention has been described in terms of a preferred embodiment, it is not intended that the invention be limited to this embodiment. Modifications within the spirit of the invention will be apparent to those skilled in the art, and the scope of the present invention is defined by the claims that follow.

1. A method of generating a protein model, the method including the steps of:
(A) identifying a 3-dimensional structure of a protein;
(B) obtaining positional data for the protein including Cartesian coordinates;
(C) converting the Cartesian coordinates so generated to animation data; and
(D) employing a software program to generate an animated model of a protein using animation data.

2. A method of generating a protein model as defined in claim 1, including the further steps of:
using a melscript program to describe positional relationships between predetermined portions of a protein; and
using said melscript program, producing an animation of the protein.

3. The method of generating a protein model a protein as defined in claim 2, including the further step of:
using information to generate spheres to illustrate protein portions; and
connecting said spheres to produce a preliminary protein animation image.

4. The method of generating a protein model a protein as defined in claim 1, including the further steps of:
using NURBS to connect the spheres; and
using smoothing techniques to refine the protein animation image.

5. The method of generating a protein model a protein as defined in claim 1, including the further steps of:
rendering the protein animation image in order to give depth to the preliminary protein animation image.

6. The method of generating a protein model a protein as defined in claim 5, wherein said rendering step includes the further step of:
setting render globals for the particular image, including setting global attributes for an animation scene.

7. The method of generating a protein model a protein as defined in claim 6, including the further steps of:
employing a render editor to set the render globals; and
turning a motion blur function off to reduce shadows behind the animation scene.

8. The method of generating a protein model a protein as defined in claim 6, including the further steps of:
selecting key frame, lighting, color and camera angles to refine the animation to produce a final model of a protein.

9. A system for producing a protein model comprising:
(A) means for identifying the 3-dimensional structure of a target protein using Cartesian coordinate information;
(B) a software program that utilizes said Cartesian coordinate information of said target protein and which uses said coordinate information to produce animation data for use in creating an animation of said target protein; and
(C) means for displaying a visual animation of said target protein using said data.

10. The system as defined in claim 9 wherein said software program is includes melscript.

11. The system as defined in claim 9 wherein said software program includes information based on NURBS and spheres for producing animation data.
